(19) United States
(12) Patent Application Publication
(10) Pub. No.: US 2004/0094373 A1
(43) Pub. Date: May 20, 2004

(54) Cam driven electric parking brake actuator

(76) Inventor: Eric John Klammer, Davison, MI (US)

Correspondence Address: Thomas N. Young, Young & Basile, P.C., Suite 624, 3001 West Big Beaver Road, Troy, MI, 48084, US

(21) Appl. No.: 10/712,863

(22) Filed: Nov. 13, 2003

Related U.S. Application Data
(60) Provisional application No. 60/427,519, filed on Nov. 19, 2002.

(51) Int. Cl. B60L 7/00

(52) U.S. Cl. 188/162

(57) ABSTRACT

An electrically activated parking brake can include a constant power motor for actuating a cam that is connected via a cable to the parking brake. The cam has a variable radius perimeter such that a roller follower or linkage operably engages the cam by rolling along the perimeter of the cam. The follower will move radially outward from the center of rotation, as the cam rotates in a positive direction. A cable is operably attached to the follower and to a cable mechanism operably associated with a brake system on a wheel. The brake system applies the brakes when the cable or linkage is pulled by the follower after the cam rotates a full cycle.

### FIELD OF THE INVENTION

The present invention relates to a cam driven electric parking brake and a method for designing a cam profile for the same.

### BACKGROUND OF THE INVENTION

Parking brakes are used to prevent vehicles from moving after they have been parked and to stop the vehicle in emergency braking situations. Prior art manual parking brakes typically include either a hand pull lever positioned adjacent a console or a foot activated pedal in the vehicle. The manual parking brake mechanism is activated through a brake actuator, such as a cable, which connects with the brakes located at the rear wheels of the vehicle. A variety of problems are associated with a manual parking brake. One of these problems is that the lever takes up valuable space.

Electric parking brake systems, activated with a push button, have been developed to provide more room in the vehicle. However, while these systems provide added vehicle room, they do not provide an efficient mechanism to activate the parking brake. The present invention solves this and other problems of the prior art.

### SUMMARY OF THE INVENTION

The present invention provides an electrically activated parking brake actuator for a vehicle. The actuator includes an electric motor which rotatably drives a cam. The cam has a variable radius perimeter. A follower operably engages the cam and moves along the perimeter of the cam as the cam is rotated. The follower moves radially outward from the center of rotation as the cam rotates. A brake actuator, such as a cable or linkage, having a first and second end is provided. The first end of the brake actuator is operably attached to the follower and the second end is operably attached to a parking brake.

A method for designing a cam profile for an electrically actuated parking brake is also provided. In designing the cam profile the initial load and the final load of the parking brake are provided. The required stroke of the parking brake is also provided. Knowing these parameters and using an initial radius for the cam, subsequent cam radii can be calculated based on the required stroke and the difference between the initial load and the final load.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings, wherein like reference numerals refer to like parts throughout the several views, and wherein:

FIG. 1 is an exploded view of an apparatus for electrically actuating a parking brake;

FIG. 2 is an enlarged plan view of the cam follower shown in FIG. 1;

FIG. 3a is a plan view of the cam with the cam follower in an initial position;

FIG. 3b is a plan view of the cam with the cam follower in an applied position;

FIG. 4 is a graph showing power utilization of a prior art system compared to the present invention;

FIG. 5 is schematic of the cam showing angles used for designing the cam profile; and

FIG. 6 is a block diagram showing the interconnection between the fault detection system and the brake actuator.

### DESCRIPTION OF THE PREFERRED EMBODIMENT

The present invention provides an electrically activated parking brake which includes a cam driven by an electric motor. The cam is configured to optimize the manner in which the electric motor activates the parking brake.

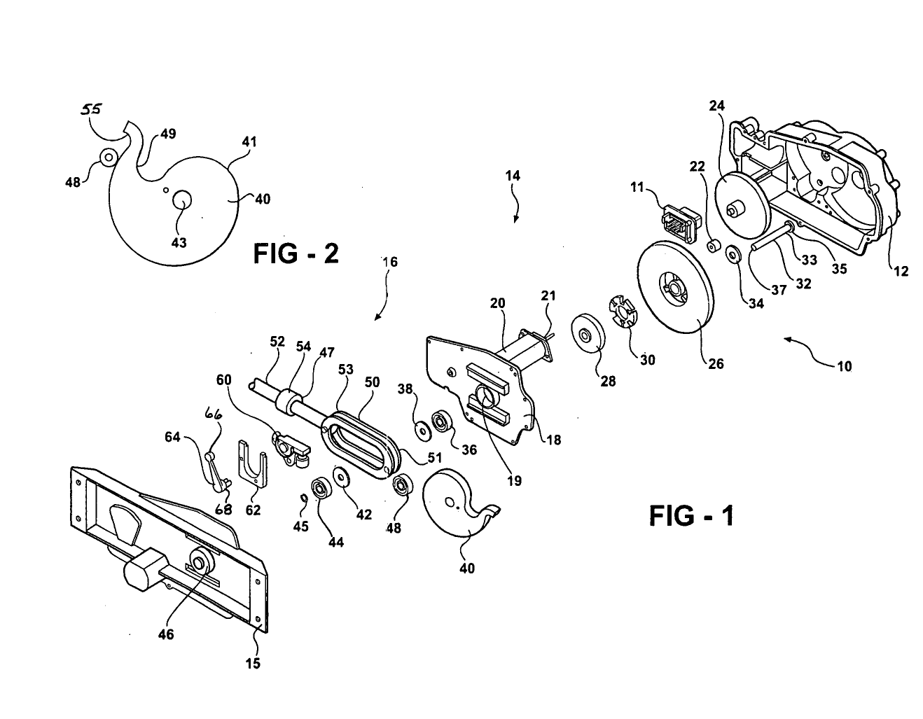

Referring to FIG. 1, an electric parking brake actuation assembly 10 is shown. Parking brake actuation assembly 10 has a housing 12 for assembling internal components therein. A gear train assembly 14 and a cam assembly 16 are assembled in housing 12, and a mid-plate 18 separates the two assemblies 14 and 16. A cover 15 encloses the gear train assembly 14, the cam assembly 16, and the mid-plate 18 within the housing 12.

An electric motor 20 having an output shaft 21 drives the gear train 14. A pinion gear 22 is positioned on the end of the output shaft 21. The pinion gear 22 meshes with and drives an intermediate gear 24. The intermediate gear 24 is meshed with and drives a first output gear 26. The output gear 26 drives a rubber isolator 30. It is understood that the rubber isolator 30 is designed to prevent damage from impact loading in the gear train 14 as the cam assembly 16 reaches the end of its travel. The isolator 30 meshes with and drives a drive plate 28. A main shaft 32, having splines 33 thereon, engages with and is driven by the drive plate 28. The main shaft 32 preferably includes a proximal end 35 which engages a washer 34 against the output gear 26. The main shaft 32 is supported by a first bearing 36 located in an aperture 19 which is located in the mid-plate 18.

The main shaft 32 passes through the mid plate 18 and engages a cam 40 in such a manner that as the main shaft 32 rotates in response to rotation of the output shaft 21 of the motor 20, the cam 40 also rotates. The cam 40 is operably connected to the main shaft 32 through the splines 33. A first washer 38 and a second washer 42 act as spacers and are positioned on either side of the cam 40. The main shaft 32 is supported at its distal end 37 by a second bearing 44 located in a pocket 46 in the cover 15. A C-clip 45 retains the components engaged with the main shaft 32 by preventing the components from sliding off the end 37 of the main shaft 32.

A cam follower 48 engages the cam 40 and is operably connected to a brake actuator, which as illustrated is a cable 52 preferably acting through a clevis 50.

The clevis 50 has a first end 51 and a second end 53. The clevis 50 is preferably connected to a tension adjustor mechanism 54. The tension adjustor mechanism 54 is of the type described in Japan Publication Number 62-292913, which is incorporated herein by reference. The tension adjustor mechanism 54 is provided to ensure constant and adequate tension to the cable 52 so as to automatically avoid both permanent elongation and excessive tension on the cable 52. The tension adjustor mechanism 54 is designed such that the cable tension adjusting action is performed every time the parking brake is actuated. In general, the tension adjusting mechanism 54 includes a rod connected to an end of the cable 52 in such a manner that the rod does not rotate. A torsion spring (not shown) for providing tension to the cable 52 is operably connected to one end of the rod. It is understood, however, that other types of springs could be included, such as compression springs. A screw and nut assembly (not shown) is attached to the rod in such a manner that the nut can freely rotate and move in an axial direction when the parking brake is not activated. Means for rotatingly locking the nut is employed when the parking brake is activated.

It is understood that a second option for automatically adjusting the tension of the cable 52 can include a second motor (not shown) operably connected to the tension adjustor mechanism 54 to make the cable 52 taut prior to engaging the main motor 20 to activate the parking brake.

FIG. 1 also illustrates a position sensor 60 that is operative for sensing the position of the adjustor mechanism 54. The sensor 60 is supported within the housing 12 by a bracket 62 that is attached to the housing 12. In operation, the sensor 60 operably engages the adjustor mechanism 54 through a lever 64. One end 66 of the lever 64 is pivotally connected to a flange 47 located on the adjustor mechanism 54, while a second end 68 is attached to the position sensor 60. Movement of the cable 52 causes the lever 64 to pivot about its connection with the position sensor 60, which in turn produces a signal in response to the movement of the lever 64 that can be used for determining the position of the cam 40. The signal is received by a controller (not shown), which controls the operation of the motor 20 in response to the signal. Power is provided to the motor 20 and all appropriate electrical connections are made through an electrical connector 11 that is preferably packaged adjacent the housing 12.

With reference to FIG. 2, the cam 40 is shown with a variable radius perimeter 41. The cam 40 rotates in a circuitous fashion about a center 43. The cam follower 48 operably engages the cam 40 by moving along the perimeter 41 of the cam 40 as the cam 40 rotates. The cam 40 has a positive stop 55 and a pocket 49. The cam follower 48 is captured by the pocket 49 in an initial position and abuts against the stop 55 in an applied position.

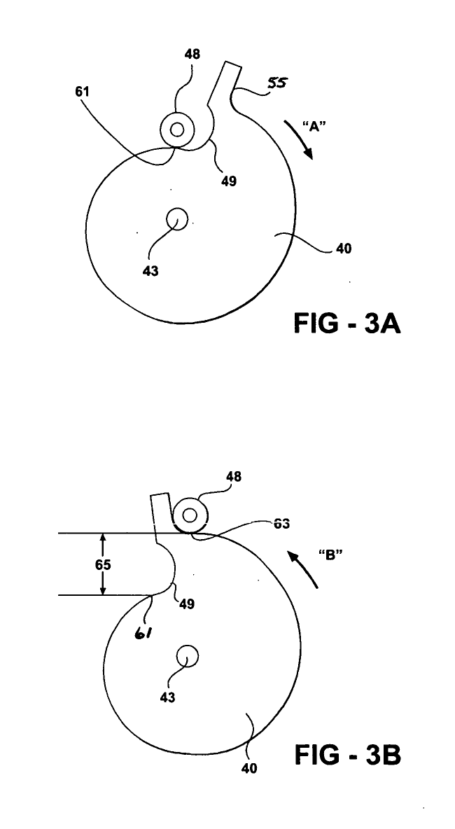

With reference to FIGS. 3A and 3B, the cam 40 is shown in an initial position 61 and in an applied position 63. The cam 40 has a total system stroke 65, which is the difference between the radial position of the cam follower 48 in the initial position 61 and the radial position of the cam follower 48 in the applied position 63. The follower 48 moves radially outward from the center 43 of the cam 40 as the cam 40 rotates in a direction indicated by arrow “A”. The cam follower 48 decreases its distance from the center 43 as the cam 40 rotates in the direction of arrow “B”. The variable radius allows the motor 20 to operate at a substantially constant design torque even though the load on the system increases proportionally as the parking brake (not shown) is applied.

The positive stop 55 prevents the cam follower 48 from moving past its position when the parking brake is applied, and the pocket 49 prevents the cam follower 48 from rotating past the pocket 49 when the parking brake is released. Once the cam 40 rotates through its full cycle, the cam follower 48 is restricted from moving past stop 55. At this point, the cam follower 48 is at its farthest distance from the center 43 and the parking brake is fully engaged. The motor 20 is reversible which permits rotation of the cam 40 in a direction indicated by letter “B”. Rotating the cam 40 in the direction of arrow “B” causes the cam follower 48 to move radially inward relative to the center 43 of the cam 40, which releases the parking brake.

Referring also to FIG. 6, the parking brake actuator 10 may include fault detection capability 76 for discovering problems with the brake system. The fault detection 76 diagnoses open circuits on the adjustment motor 78, if present, and the main motor 20. The fault detection capability 76 includes the ability to detect the time to apply the main motor 20 after the command from the controller 80 is given. The fault detection capability further includes determining if the motor 20 is not moving under the command of the controller 80 or whether the motor 20 is moving faster or slower than a predetermined design speed. The controller 80 can be reprogrammed by reflashing a memory chip 82, and can be connected to a vehicle electronics network 84. It is understood that the fault detection capability 76 could be incorporated into the controller 80.

Advantageously, the electric brake actuator system 10 disclosed by the present invention can be located in the same area as a standard non-electric parking brake equalizer. The parking brake can be activated through a brake actuator, such as a cable or linkage. If cables are used, the cable routing is substantially identical to current vehicle routing systems and will not take any more space than prior art designs.

In operation, the parking brake is preferably actuated by an occupant of the vehicle by pressing a button. Upon pressing the button, the motor 20 initiates rotation of the cam 40 through the gear train 14 and the main shaft 32. The cam follower 48 is displaced in a linear fashion as the cam 40 is rotated. The cam follower 48 moves radially outward from the center of rotation 43, causing the brake cable 52 to engage the parking brake. The sensor 60 detects the position of the cam follower 48 and the direction of rotation of cam 40 and prevents the motor 20 from trying to rotate the cam 40 past stop 55. The parking brake is disengaged when the occupant pushes the release button and the entire process is reversed.

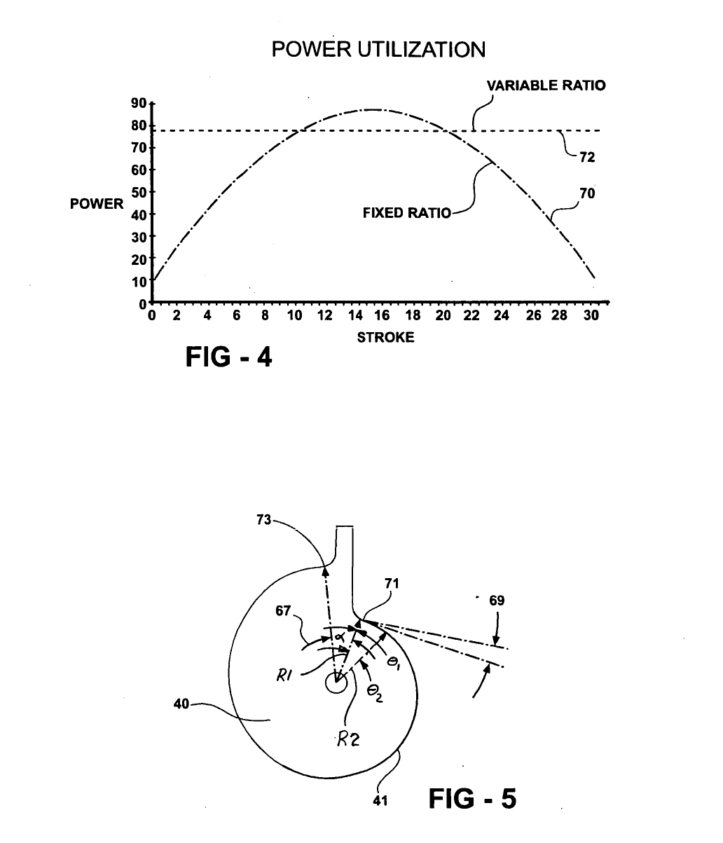

With reference to FIG. 4, a comparison of the power utilization of the electric motor 20 used to drive the variable ratio cam 40 of the present invention as opposed to a fixed ratio drive mechanism, such as a screw drive or the like. In particular, curve 70 illustrates power utilization with the fixed ratio drive while line 72 illustrates power utilization of the variable ratio cam 40 of the present invention. The power distribution curve 70 of the fixed ratio drive has a parabolic shape, which indicates that the motor 20 is not being used in an efficient manner. The inefficient use of power with the fixed ratio drive requires the size of the motor to be larger and/or the time for applying the brakes to be greater relative to the motor 20 utilizing the variable ratio cam 40.

In contrast, curve 72, which corresponds to a motor 20 utilizing the variable ratio cam 40 of the present invention, illustrates a substantially constant power utilization during the entire brake actuation period. This allows the motor 20 to be more precisely specified for a given parking brake system. An added benefit to the constant power system is that it provides a basis for the noise and speed of the system to be substantially constant during the braking sequence.

It is understood that the preferred variable ratio drive is a cam in the form of a variable ratio plate. However, those of skill in the art will recognize that a cam can take other forms. For example a variable ratio slot machined in a groove may be provided. Alternative designs may also rotate beyond 360 degrees.

A method for developing a cam profile for an electric brake actuator is also provided. The method can be used to develop a cam or variable ratio drive device to correlate a variable force to a constant torque load. It is understood that other methods are available and that this method is merely illustrative. This method assumes that the brake load increases linearly relative to the brake cable 52 travel. The motor torque is a constant, and the cam follower 48 makes line contact on the cam 40. The stroke necessary to actuate the parking brake, the initial loading of the cable 52, and the final loading of the cable 52, can be predetermined and thus provided for when designing the cam profile. Using these input variables, the work required of motor 20 can be calculated using the following equation:

Work=½×Total System Stroke×(Final Load−Initial Load)

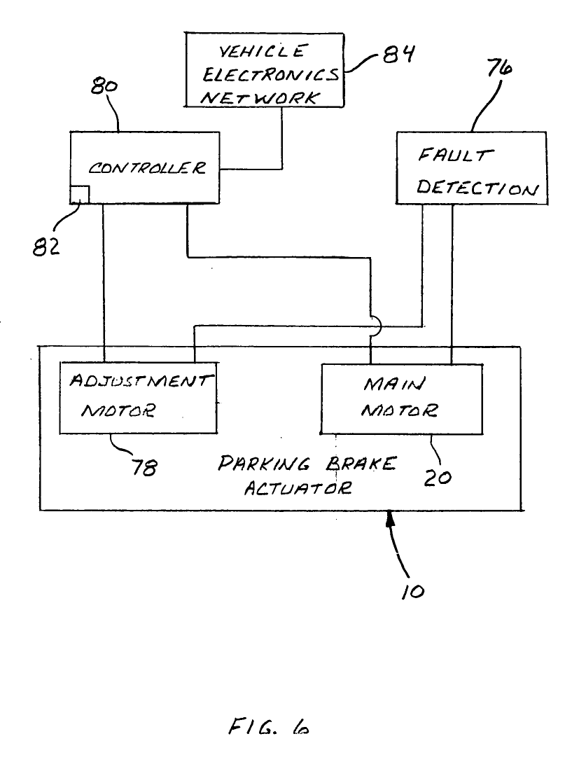

The maximum available rotation for the cam 40 is preferably equal to 360 degrees−α, as shown in FIG. 5. Upon determining the work required by the cable and the available rotation, the required motor torque is calculated from the following equation:

Torque=Work÷((360−α)×3.14159÷180)

The load at any given point of brake actuation can be calculated by assuming the load linearly increases from the initial loading to the final loading. The cam radius and the angular displacement for each radius point can be determined from the following equations:

Radius=Total System Stroke+Initial Radius; and

Force=Initial Load+spring constant×Total System Stroke

The work done between individual discreet points=½×(second point load−first point load)×(second point stroke−first point stroke)+first point load×(second point stroke−first point stroke).

The angular travel in radians equals the work done between points divided by the torque.

From this information, it is possible to calculate discrete co-ordinates of a cam profile that will provide a constant torque motor.

An illustrative example for designing a cam profile for an electric brake actuator is described below.

Assuming the following values:

Total System Stroke=0.050 M

Initial Stroke=0.000 M

Initial Load=100 N

Final Load=5100 N

Spring Constant=(5100−100)÷(0.050−0)=100000 N/M

Work Required=½0.050×(5100−100)=125 NM

Assuming the geometry of the cam 40 requires 30 degrees of non-productive area, the required motor torque is:

Torque=125÷((360−30)×3.14159÷180)=21.7 NM

Assuming the initial radius (R1) is 0.020 M, then the radius (R2) at the next point along the cam profile can be calculated. For example:

If:

R1=0.020, Theta1=0

R2=0.021, Theta2=unknown

Then:

Force=100+0.001×100000=200 N

Work done=½×(200−100)×(0.021−0.020)+100×(0.021−0.020)=0.150 NM

The angular travel required=0.150÷21.7=0.0069 rad

Therefore, Theta2=0.0069

This process can be repeated for an infinite number of additional points and can be easily done on a computer using a spreadsheet or similar type program. With reference to FIG. 5, there is shown a schematic of the cam 40 illustrating various angles used in designing a constant torque cam profile. The schematic illustrates the cam 40 with an initial radius 71, a final radius 73, a slope angle 69, and an angle theta 67. The initial radius 71 and the final radius 73 is determined by the total stroke 65 required to actuate the parking brake. Angle alpha 67 represents the angular distance of cam perimeter 41 that is unusable for the cam follower to traverse thereon.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A parking brake actuator for a vehicle comprising:
an electric motor;
a cam having a variable radius perimeter, the cam being rotatably driveable by the electric motor;
a cam follower engageable with the cam and operably connected to a parking brake, whereby the cam follower travels along the perimeter of the cam as the cam is rotated causing the cam follower to move radially outward from a center of rotation and the parking brake to be applied.

2. The parking brake actuator of claim 1, further comprising a cable having a first end and a second end, the first end operably connected to the cam follower and the second end operably connected to the parking brake.

3. The parking brake actuator of claim 1, wherein the cam is operable between an initial position and an applied position.

4. The parking brake actuator of claim 3, wherein the radius of the cam at the point of contact between the cam follower and the cam when the cam is in the initial position is less than the radius of the cam at the point of contact between the cam follower and the cam when the cam is in the applied position.

5. The parking brake actuator of claim 3, wherein the parking brake is disengaged when the cam is in the initial position and is engaged when the cam is in the applied position.

6. The parking brake actuator of claim 3, wherein the power requirement of the electric motor remains substantially constant as the cam is rotated from the initial position to the applied position.

7. The parking brake actuator of claim 3, wherein the electric motor produces a torque that remains substantially constant as the cam is rotated from the initial position to the applied position.

8. The parking brake actuator of claim 3, wherein the cam includes a positive stop for preventing the cam from being rotated past the initial position.

9. The parking brake of claim 3, wherein the cam includes a pocket for preventing the cam from being rotated past the applied position.

10. The parking brake actuator of claim 1, wherein the parking brake restricts movement of at least one wheel of the vehicle when the cam has rotated a full cycle.

11. The parking brake actuator of claim 1, wherein the cam has a full rotational cycle of less than 360°.

12. The parking brake actuator of claim 1, wherein the electric motor is reversible.

13. The parking brake actuator of claim 1, wherein the cam follower is comprised of a bearing.

14. The parking brake actuator of claim 1, wherein the cam follower has an outer periphery that engages the perimeter of the cam.

15. The parking brake actuator of claim 1, further comprising a cable for operably connecting the cam follower to the parking brake.

16. The electrically actuated parking brake actuator of claim 15 further comprising:
a clevis for connecting the cam follower and the cable.

17. The parking brake actuator of claim 1, further comprising a linkage mechanism for operably connecting the cam follower to the parking brake.

18. The parking brake actuator of claim 1, wherein the electrical motor is operably connected to the cam by a gear train.

19. The parking brake actuator of claim 17, wherein the gear train includes at least one isolator.

20. The parking brake actuator of claim 1, further comprising a sensor for detecting the rotational position of the cam.

21. A method for actuating an electric parking brake having a variable radius cam, comprising the steps of:
depressing a lock switch;
signaling a motor to actuate the variable radius cam;
moving a cam follower along the variable radius of the cam; and
actuating a brake as the roller follower connected to a cable moves linearly outward.
